(19) United States
(12) Patent Application Publication
(10) Pub. No.: US 2003/0224121 A1
(43) Pub. Date: Dec. 4, 2003

(54) Paint applicator

(76) Inventor: David Karroll, Rimbey (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/063,959

(22) Filed: May 29, 2002

(51) Int. Cl. B05C 17/02

(52) U.S. Cl. 427/428; 15/230.11; 15/144.1; 492/13; 492/19

(57) ABSTRACT

A paint applicator includes a paint roller having a bevelled nap at one end and a separator attached to or integral with the roller at one end. The roller is used with a pivotally adjustable handle.

### BACKGROUND OF INVENTION

The present invention relates to a paint applicator and, in particular, to a paint applicator having a pivotally adjustable handle and improved edge painting capability. The present invention also relates to a method of interior painting.

Residential painting may involve either new construction or repaints of existing homes. New construction painting is typically provided by professionals who are skilled in the art of painting and are continually looking for tools, products and application methods to provide a high quality paint job with a minimum of effort. Occasionally, homeowners will attempt to paint their own new homes.

Typically, repaint jobs are attempted by the owner, although many people will employ professionals for these jobs. Many homeowners who have attempted to do their own painting, know it requires skill, tools and time. One of the common problems is hitting the ceiling or an adjacent wall with a roller and or the time involved in taping off surfaces that are not to get paint on them.

A typical cost allocation of a professional paint job is broken down as 10-20% materials and 80-90% labour. Any products, tools or systems that can be employed to reduce labour costs and improve the quality of the paint job are in high demand.

Interior surfaces in a house or commercial premises are typically painted using a combination of roller application and brush applications. Paint is brushed on near edges or surfaces which are not to be painted, such as around doorways, windows and ceilings. These surfaces are usually masked with tape to prevent contact with paint. “Cutting in” around these surfaces with a brush is a time-consuming and laborious exercise.

Various devices have been proposed to make this task easier. Simple straightedge guards used in combination with a brush provides some benefit. It is known to use edge guards in combination with rollers, as seen in U.S. Pat. No. 5,444,891. These guards do not work entirely satisfactorily. If the roller is positioned too close to the guard, paint will build up along the guard and will likely find its way onto the edge or surface which is not to be painted. Alternatively, if the roller is set apart from the edge guard, a uniform painted surface right up to the edge cannot be achieved. Furthermore, these devices cannot be used along irregular surfaces such as textured ceilings and or other irregular surfaces.

Therefore, there is a need in the art for an improved paint applicator system which mitigates the difficulties of the prior art.

### SUMMARY OF INVENTION

The present invention is directed to a paint applicator and a method of painting which may permit more efficient and effective painting of interior surfaces.

In one aspect of the invention, the invention comprises a paint applicator comprising:(a) a cylindrical roller sleeve having an exterior textured surface for applying paint to a surface, wherein said roller has a first end and a second end, and the textured surface at the second end is bevelled away from the second end; and (b) a separator attached to or forming part of the second end and having an outside surface, wherein said separator spaces the second end away from a non-painted surface which joins a surface to be painted at an angle.

The degree of bevelling is such that no part of the textured surface may extend past a plane tangent to the separator outside surface and perpendicular to a roller longitudinal axis.

In another aspect, the invention may comprise a method of painting interior walls of a room having a ceiling, comprising the steps of:(a) using an cylindrical paint roller having an exterior textured surface for applying paint to a surface, wherein said roller has a first end and a second end, and the textured surface at the second end is bevelled back from the second end; a separator attached to or forming part of the second end; a pivotally adjustable elongated handle;(b) remaining near the centre of the room, painting the surfaces close to the ceiling by angling the handle such that the roller is substantially vertical and the separator touches the ceiling; and (c) painting the remainder of the interior walls where the walls come in close proximity to trims and or other surfaces not to be painted by adjusting the angle of the handle.

### BRIEF DESCRIPTION OF DRAWINGS

The invention will now be described by way of an exemplary embodiment with reference to the accompanying simplified, diagrammatic, not-to-scale drawings. In the drawings:

FIG. 1 is an illustration of an embodiment of the present invention.

FIG. 2 is a view of the roller end of one embodiment of a paint applicator.

FIG. 3A is a detailed view of the pivoting means of one embodiment.

FIG. 3B is a detailed view of an alternative pivoting means.

FIG. 4 is a side view of the embodiment shown in FIG. 3A.

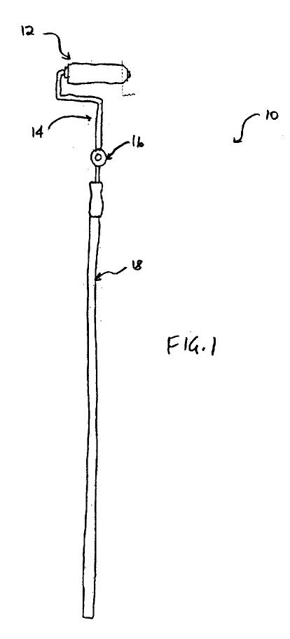

### DETAILED DESCRIPTION

The present invention provides for a novel paint applicator. Also provided is a novel method of painting interior walls. When describing the present invention, all terms not defined herein have their common art-recognized meanings.

The apparatus depicted in the Figures comprises a paint applicator (10) which includes a roller (12), a neck (14) having pivoting means (16) and an elongated handle (18).

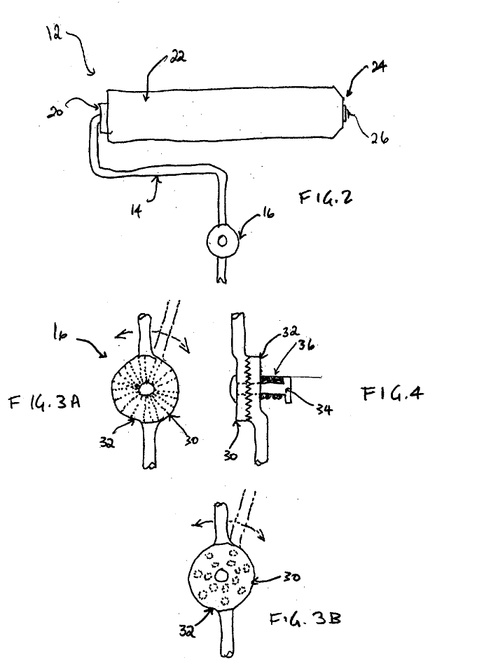

As shown in FIG. 2, the roller (12) includes a roller holder (20) upon which a roller sleeve (22) is slidingly affixed, as is well known in the art. The sleeve (22) bears an external textured surface which retains and applies paint, again as is well known in the art. In one embodiment, the surface is a napped surface with between about a ¼ inch to about a 1 inch nap. The small nap rollers are suitable for smooth surfaces as drywall while the thicker naps are useful for heavily textured surfaces such as brick or concrete surfaces. The far end (24) of the roller sleeve (22) has the nap bevelled as is shown in FIG. 2.

The nap may be bevelled at about a 45° angle. The nap should be bevelled at a sufficient angle so that, when the nap is wet with paint and flattened, the nap does not extend past the end of the separator (26) described below.

The bevelled end (24) has a small separator (26) which is affixed to or is integral with the far end of the roller (12). The combination of the separator (26) with the bevelled nap roller sleeve allows the roller (12) to be used right up against surfaces at a right angle to the surface being painted, such as an adjacent wall where the two walls meet in a corner, a ceiling or door/window or other trim. When high-quality low splatter paint is used, and with the correct thickness of separator and correct bevel angle on the nap, the roller (12) may be used against other surfaces without the need for an edge guard or taping off the surface which is not to be painted. One skilled in the art may determine the correct thicknesses and bevel angles required with minimal and routine experimentation.

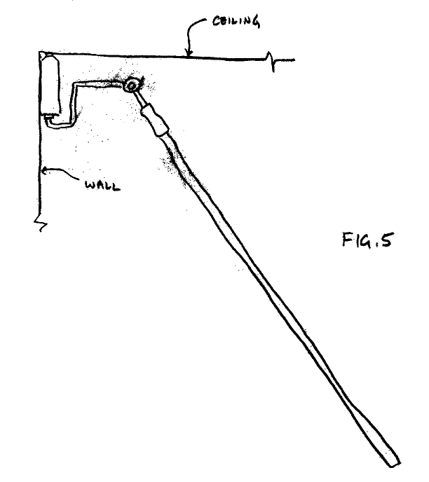

The pivotally adjustable neck (14) includes two pieces each having a mating disk (30, 32). The mating surfaces of the disks have complementary ridges (shown in FIG. 3A or 4) or raised dots and pits (shown in FIG. 3B). When the two disk are mated together, the neck acts as a unitary piece. The two disks can be rotated in relation to each other to pivot the roller as is apparent. In one embodiment, the two disks are biased together by a retaining bolt (34) and a coil spring (36). This configuration permits quick and convenient changes in the pivot angle of the roller. Alternatively, a bolt and wingnut, or other equivalent manually operable attachment means may be used.

The handle may be extendible or retractable to vary its length, as it well known in the art.

The apparatus may be used with an extension handle to paint an entire room by standing near the centre of the room and adjusting the pivot angle of the neck. As shown in FIG. 5, the upper ends of walls, abutting the ceiling, may be painted by adjusting the pivot angle as shown. One skilled in the art will readily appreciate the adjustments of the pivot angle necessary to paint typical interior walls. This method of painting substantially reduces or in many cases eliminates the need to “cut in” near the ceiling and door/window frames with a brush, substantially reducing the time necessary to paint a room. This method of painting also permits the elimination of a common problem where a brush cut line will leave a different texture than the roller painted areas. This appearance or phenomena is known in the trade as “picture framing” where the brushed areas appear to be a different color. With the present invention, this problem may be avoided because a roller is used to paint all areas.

The method also permits more convenient painting overtop of kitchen cabinets and in other difficult to reach areas like stairwells and other overheight locations, particularly with ability to extend the handle and change the angle of the device.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A paint applicator comprising:
(a) a cylindrical roller sleeve having an exterior textured surface for applying paint to a surface, wherein said roller has a first end and a second end, and the textured surface at the second end is bevelled away from the second end; and
(b) a separator attached to or forming part of the second end and having an outside surface, wherein said separator spaces the second end away from a non-painted surface which joins a surface to be painted at an angle.

2. The paint applicator of claim 1 wherein the textured surface at the second end is bevelled sufficiently such that no part of the textured surface may extend past a plane tangent to the separator outside surface and perpendicular to a roller longitudinal axis.

3. The paint applicator of claim 2 wherein the textured surface at the second end is bevelled at about a 45° angle.

4. The paint applicator of claim 2 further comprising a roller holder affixed to an elongated handle, wherein the handle is pivotally adjustable.

5. The paint applicator of claim 4 wherein the elongated handle comprises at least two portions, each portion having a disc comprising a mating surface, wherein each mating surface comprises a plurality of projections and depressions such that the projections of one disc fit within the depressions of the other disc when the two discs are pressed together.

6. The paint applicator of claim 5 wherein the mating surfaces of the discs are radially serrated.

7. The paint applicator of claim 5 wherein the mating surfaces of the discs comprise corresponding bumps and depressions.

8. The paint applicator of claim 5 further comprising means for resiliently biasing the two discs together, which biasing means may be manually overcome to adjust the position of one disc relative to the other.

9. The paint applicator of claim 7 wherein the biasing means comprises a bolt which passes through both discs and a coil spring which acts between one end of the bolt and one disc.

10. A method of painting interior walls of a room having a ceiling, comprising the steps of:
(a) using an cylindrical paint roller having an exterior textured surface for applying paint to a surface, wherein said roller has a first end and a second end, and the textured surface at the second end is bevelled back from the second end; a separator attached to or forming part of the second end; a pivotally adjustable elongated handle;
(b) remaining near the centre of the room, painting the surfaces close to the ceiling by angling the handle such that the roller is substantially vertical and the separator touches the ceiling; and
(c) painting the remainder of the interior walls where the walls come in close proximity to trims and or other surfaces not to be painted by adjusting the angle of the handle.
